(19) United States
(12) Patent Application Publication
(10) Pub. No.: US 2006/0247838 A1
(43) Pub. Date: Nov. 2, 2006

(54) Method for detecting a real value of a manipulated variable, particularity of a steering angle

(75) Inventor: Urs Bauer, Ludwigsburg (DE)

Correspondence Address: Craig Hallacher;Continental Teves Inc, One Continental Drive, Auburn Hills, MI, 48326, US

(73) Assignee: Continental Teves AG & Co., oHG

(21) Appl. No.: 10/564,335

(22) PCT Filed: Jun. 24, 2004
(86) PCT No.: PCT/EP04/51231

§ 371 Date: Jul. 5, 2006

(30) Foreign Application Priority Data
Jul. 11, 2003 (DE) 10331782.1
Oct. 10, 2003 (DE) 10347805.1

(51) Int. Cl. B62D 6/00

(52) U.S. Cl. 701/41; 180/443

(57) ABSTRACT

The invention provides a process for the determination of an actual value of a control variable set by an actuator in accordance with a theoretical value. The process is thereby characterized in that, a partial value of an actual value set in accordance with a theoretical partial value consisting of a total of theoretical partial values is determined in dependence on the theoretical partial value in an actuator model formed with at least one parameter corresponding to the partial value, whereby the value of the parameter is determined by means of a deviation between the theoretical total value and a determined actual total value of the control variable. It is suitable, in particular, for the determination of an actual value of a steering angle on steerable wheels of a vehicle, which can be used in a vehicle reference model of a driving dynamics adjustment.

### BACKGROUND OF THE INVENTION

The invention relates to a process for the determination of an actual value of a control variable set by an actuator.

It is suitable, in particular, for the determination of an actual value of a steering angle on steerable wheels of a vehicle which can be used in an adjustment of driving dynamics.

A comparison of an actual behavior determined by different vehicle sensors with a theoretical behavior determined in a vehicle model usually serves as the basis for an adjustment of driving dynamics for vehicles. Such an adjustment of driving dynamics is described, for example, in the German patent disclosure document DE 195 15 058 A1.

The theoretical behavior of the vehicle is determined by means of the vehicle model, particularly in dependence on a steering angle on the steerable wheels that represents the desire of a driver for a given direction. In the vehicle model described in the patent disclosure document DE 195 15 058 A1, the steering angle set on the wheels by the driver by means of the steering device of the vehicle is thereby taken as the basis for the steering angle representing the desire of a driver for a given direction. This steering angle can be measured on the steering wheel or on the wheels by means of a steering angle sensor.

It is known, however, to superimpose a steering movement initiated by the driver of a vehicle with an additional steering movement initiated by a control unit. A steering angle on the steerable wheels of the vehicle thereby results as the sum of the steering angle commanded by the driver and of a supplemental steering angle, in accordance with which the additional steering movement is carried out.

In this connection, an adjustment of the yaw rate, in which the supplemental steering angle is determined in dependence on a yaw movement of the vehicle, appears in the German patent disclosure document DE 197 51 227, for example.

It is known, furthermore, to change a transmission ratio between the steering angle on a steering device of the vehicle, such as on a steering wheel, for example, and the steering angle of the steerable wheels of the vehicle in a speed-dependent manner by setting a supplemental steering angle determined in dependence on vehicle speed.

At low vehicle speeds, a very direct steering transmission is thereby set in order to minimize the steering exertion for the driver during maneuvering, whereas a very indirect transmission ratio is set at high speeds in order to reduce nervousness during steering.

The supplemental steering angle is usually set by means of a planetary gear controlled by an actuator, whereby the actuator is typically designed as an electrical motor to which control signals containing a theoretical value of the supplemental steering angle are transmitted.

### SUMMARY OF THE INVENTION

The invention now relates to the problem of determining the portion of the steering angle set on the steerable wheels corresponding to the desire of a driver for a given direction if the steering angle set by means of the superimposition steering is composed of several portions, which portions are transmitted to the actuator as theoretical partial values.

The different portions of the supplemental steering angle set can not be measured by sensors but, upon sufficiently high dynamics of the actuator, however, the supplemental steering angle is set so rapidly that the theoretical partial values can often be used as actual partial values.

In many situations, such as, in particular, after starting the vehicle at low temperatures, for example, the dynamics of the actuator are restricted in such a manner that a considerable time delay arises upon the setting of the supplemental steering angle, and the theoretical partial values do not represent the specific actual partial values.

It is conceivable, of course, to compute the actual partial values from an actual total value of the supplemental steering angle determined by a steering angle sensor in a manner corresponding to the ratio between a corresponding theoretical partial value and a theoretical total value or, in another way, from the theoretical values, but this does not take into consideration, however, the fact that the actual partial values are, upon reduced dynamics of the actuator, also decisively determined by the rates of change of the theoretical partial values termed gradients.

Such processes, which are based upon computation by means of the theoretical values, consequently do not allow any reliable determination of actual partial values upon reduced actuator dynamics.

The task that forms the basis for the invention is thus that of creating a process that makes possible a determination of a reliable assessed value for the partial actual values that is as rapid as possible, even if the actuator indicates an unknown control behavior.

In accordance with the invention, this task is solved by the process discussed in detail below.

The invention thereby provides, in particular, that a process for the determination of an actual value of a control variable set by an actuator in accordance with a theoretical value is carried out in such a manner that a partial value of an actual value set in accordance with a theoretical total value consisting of a sum of theoretical partial values is estimated in dependence on the theoretical partial value corresponding to the partial value in an actuator model formed with at least one parameter, whereby the value of the parameter is determined by means of a divergence between the total theoretical value and a determined actual total value of the control variable.

In accordance with the invention, the control behavior of the actuator is consequently analyzed by means of a comparison between the theoretical total value and the actual total value of the control variable, and simulated in regard to the partial value by means of the actuator model.

This makes it possible to determine a very reliable assessed value for the actual partial value.

One particular advantage of the process in accordance with the invention consists of the fact, in particular, that the control behavior can be determined “online”, and the specific actuator behavior that is present at the point in time of a request for the actual partial value is consequently taken as the basis for the determination of the assessed value for the actual partial value.

Preferred forms of implementation of the process are characterized by the fact that the value of the parameter of the standard deviation between the theoretical total value and the actual total value of the control variable set is assigned by means of a characteristic curve and is determined in a model of the actuator or ascertained by means of a parameter estimation process. The parameter estimation process should preferably be an online-process.

In order to reduce the possible effects of an assessed value determined erroneously on the basis of a parameter determined erroneously, and in order to carry out the process in a particularly secure manner, it is provided, in one advantageous form of implementation of the process, to limit the value for the parameter to a predetermined interval.

The characteristic curve is, in the simplest case, a jump function which assigns to all values of the standard deviation that are smaller than a preset threshold value a value of the parameter corresponding to a normal dynamic of the actuator, and assigns to the values of the standard deviation that are greater than the threshold value a value of the parameter that corresponds to a reduced dynamic of the actuator. A jump function can, in particular, also be hereby used with hysteresis.

Preferably, however, the characteristic curve contains, in addition to the range of the normal dynamics and the range of the reduced dynamics, an additional medium range with, for example, a linear coordination between the standard deviation and the parameter.

During the determination of the value of the parameter by means of the model, it is advisable to use the same actuator model that also serves for the determination of the actual partial value in dependence on the theoretical partial value.

This actuator model preferably describes the dynamic transmission behavior of the actuator and reproduces the connection between an input- and an output quantity. The theoretical and actual values of the control variable are thereby suitably considered as input- and output quantities.

In models, the transmission behavior of an actuator is typically particularly described by time constants which characterize the delay upon the setting of the actual value.

In one particularly preferred form of implementation of the process in accordance with the invention, a time constant is thus determined as the parameter of the actuator model.

After a transitional time, the actuator enters into a stationary condition if the input signal does not change, or does not significantly change, over a longer period of time. During the stationary operation, the standard deviation between the actual and the theoretical value is very small, even upon reduced actuator dynamics.

One advantageous form of implementation of the process is thus characterized by the fact that a specific value is retained for the parameter if the rate of change of the theoretical total value and/or of the actual total value lies below a preset threshold value.

A new computation of the parameter value advantageously only occurs in this form of implementation if the rate of change of the theoretical total value and/or of the actual total value exceeds the threshold value.

This form of implementation is particularly preferred if a conclusion is to be made about the dynamics and the availability of the actuator from the value of the parameter since, for the evaluation of the dynamics of the actuator, a transitional behavior is exclusively of interest during the transitional time.

The process in accordance with the invention is advantageously particularly suitable for the determination of a reliable assessed value for the actual partial value of a steering angle set by a final control element of a superimposition steering.

It thereby makes it possible to reliably determine the steering angle corresponding to the desire of a driver for a given direction, which [steering angle] serves as the input quantity for a driving dynamics control unit.

In the event that the total value of the supplemental steering angle is composed of a portion for the speed-dependent change of the steering transmission and of at least one additional portion for the adjustment of the driving dynamics, the actual partial value of the supplemental steering angle that corresponds to the portion of the change of the steering transmission is thereby preferably determined.

Through an addition of this actual partial value and of the steering angle commanded by the driver, a speed-dependent steering angle results which is to be interpreted as the steering angle corresponding to the wish of the driver, and which determines theoretical behavior of the vehicle.

Additional advantages and suitable further developments of the invention result from the following description of preferred examples of implementation in reference to the figures.

### BRIEF DESCRIPTION OF THE DRAWINGS

The figures depict the following:

FIG. 1: A schematic block diagram for the representation of one form of implementation of the process in accordance with the invention, in which the value of the parameter is assigned by means of a characteristic curve;

FIG. 2: A schematic block diagram for the representation of one form of implementation of the process, in which the rate of change of the total theoretical value is additionally considered;

FIG. 3: A schematic block diagram for the representation of one form of implementation of the process in accordance with the invention, in which the value of the parameter is determined by means of a parameter estimation process;

FIG. 4: A schematic block diagram for the representation of one form of implementation of the process in accordance with the invention, in which the value of the parameter is determined by means of an inverse model;

FIG. 5: A block diagram for the representation of one additional form of implementation of the process, in which the value of the parameter is determined by means of a parameter estimation process;

FIG. 6: A block diagram for the representation of an additional form of implementation of the process in accordance with the invention, in which the value of the parameter is determined by means of a model;

FIG. 7: A block diagram for the representation of yet another form of implementation of the process.

### DETAILED DESCRIPTION OF THE DRAWINGS

The invention provides an advantageous process for the determination of an assessed value for an actual partial value of a control variable.

The process finds an advantageous application in the determination of an actual partial steering angle which is set by a superimposition steering in accordance with a theoretical total steering angle consisting of a sum of theoretical partial steering angles.

In vehicles in which a speed-dependent change of the steering transmission (VARI) is carried out by means of a supplemental steering angle set by a superimposition steering, the theoretical behavior of the vehicle must be determined from the steering angle on the wheels, which [steering angle] corresponds to the steering angle commanded by the driver in connection with the VARI.

The theoretical behavior can be set by means of a vehicle reference model, particularly on the basis of this steering angle. This is brought about by means of a vehicle control unit (ESP control unit 70), which carries out, in particular, a so-called “Electronic Stability Program” (ESP).

The ESP comprises a yaw rate adjustment (GRR), for example, in which an under-steering or an over-steering of a vehicle is detected by means of a comparison of a theoretical yaw rate determined by means of the vehicle model and of an actual yaw rate determined by means of a yaw rate sensor, and the vehicle is acted on by a yaw momentum correcting the driving behavior by means of appropriate brake-, engine, and/or steering interventions.

An ESP control unit and, in particular, the reference model used by this vehicle, are described in the German patent disclosure document DE 195 15 058 A1. The contents of this patent disclosure document should also be considered to be a component of the present application.

In addition to the GRR, a yaw momentum compensation (GMK), in which a yaw momentum is determined and adjusted, which [momentum] counteracts the interference momentum arising on different wheels of the vehicle as the result of different braking effects, can also be carried out by means of the vehicle control unit, for example. In the GMK, the yaw momentum can likewise be produced by means of steering interventions.

If a GRR and/or a GMK and a VARI are carried out in a vehicle with steering interventions, then the total supplemental steering angle set on the wheels by the superimposition steering results as a sum of the partial supplemental steering angle of the VARI, which [partial supplemental steering angle], along with the steering angle commanded by the driver, serves as the input quantity for the ESP control unit 70 and the partial supplemental steering angle of the GRR and/or of the GMK, which should not influence the vehicle model.

The individual partial supplemental steering angles, however, are only present as theoretical values, the sums of which are adjusted by the superimposition steering, and the actual total steering angle that is actually set by the superimposition steering or by the actuator of the superimposition steering, as the case may be, can not, for the reasons already noted above, be divided into its portions corresponding to the theoretical partial values.

Although, in the normal dynamics of the actuator, the theoretical partial value can be used in the vehicle model as the actual partial value, this is not always possible in the case of reduced dynamics.

It is explained in the following how the actual partial supplemental steering angle Δδ_{VARI} of the VARI can be estimated by means of the process in accordance with the invention.

This example of implementation of the invention consequently assumes a vehicle in which the driver of the vehicle can, by means of a steering wheel or other steering device, set a steering angle δ_{LR, Whl} on one or more steerable wheels of the vehicle. The steering is thereby carried out by means of a steering gear which has a steering pinion gear connected with the steering wheel, which [pinion gear] engages in a toothed rack and thus conveys the steering movements of the driver to the steerable wheels. The steering gear makes a transmission ratio of i_{LG} available between the steering angle δ_{LR, Whl} on the wheels and the steering angle δ_{LR, SZL} on the steering wheel.

The vehicle can be a two-axis, four-wheel vehicle with two steerable front wheels, for example.

It is additionally assumed that the vehicle has a superimposition steering which makes possible a free coordination between the steering wheel angle δ_{LR, SZL} and the steering angle on the wheels. This can be brought about, for example, by means of a planetary gear placed in the steering line in front of the steering pinion gear, with which [planetary gear] an electromechanical actuator engages in order to rotate the steering pinion gear relative to the steering wheel.

The superimposition steering thereby makes it possible to change both the steering transmission as well as to set a supplemental steering angle, whereby the steering angle on the steering pinion gear results as the sum of the steering wheel angle transmitted by the gear of the superimposition steering and the supplemental steering angle.

The gear of the superimposition steering is termed the AFS gear in the following, and makes a mechanical steering transmission i_{AFS} available.

Furthermore, it is assumed that a GRR and a GMK are carried out for the vehicle by means of steering interventions, and that a VARI is carried out. A theoretical partial supplemental steering angle Δδ_{GRR, req} or Δδ_{GMK, req}, as the case may be, which is set by the actuator of the superimposition steering, is thereby preset by means of the control units for the carrying out of the GRR and the GMK. The control unit for the VARI presets the theoretical partial steering angle δ_{VARI, req} to be set, which is determined in dependence on the actual steering wheel angle δ_{LR, SZL} set by the driver and is transmitted to the actuator, which [actuator] thereupon sets the partial supplemental steering angle of the VARI. The following is thereby valid:
δ_{VARI,req}=δ_{LR,SZL}+Δδ_{VARI,req},

whereby Δδ_{VARI, req} designates the theoretical partial supplemental steering angle of the VARI.

The theoretical steering angles preset by the regulating or control units thereby relate to angles on the steerable wheels, but can, however, relate to the steering pinion gear by means of the known transmission behavior of the steering gear.

The theoretical total steering angle to be set on the wheel amounts to the sum δ_{SUM, req}/i_{LG}=δ_{VARI, req}+Δδ_{GRR, req}+Δδ_{GMK, req}, whereby δ_{SUM, req} designates the theoretical total steering angle on the steering pinion gear.

It is likewise assumed that the vehicle is equipped with a driving dynamics control unit and, in particular, with an ESP control unit 70 for the carrying out of the GRR, for example, which determines the control variables in dependence on the deviation between a determined actual value of a driving condition quantity and a theoretical value computed by means of a vehicle reference model. For the computation of the theoretical value, the ESP control unit requires the actual value of the steering angle corresponding to the desire of the customer, which is what, as has been explained, the actual partial steering angle δ_{VARI} of the VARI is to be considered here.

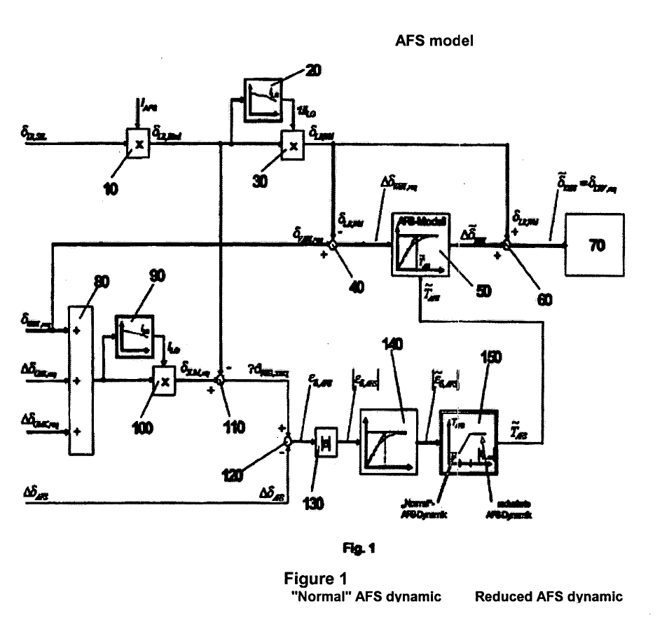

The block diagram in FIG. 1 illustrates one possible form of implementation of the process in accordance with the invention, which can be used for the determination of an assessed value \tilde{δ}_{VARI} for the actual value δ_{VARI} of the actual partial steering angle.

The actual steering wheel angle δ_{LR, SZL} on the steering wheel determined by a steering wheel angle sensor, the theoretical partial steering angle δ_{VARI, req} of the VARI in relation to the steerable wheels, the theoretical partial supplemental angle δΔ_{GRR, req} of the GRR on the wheels, the theoretical partial supplemental steering angle Δδ_{GMK, req} of the GMK on the wheels, and the actual total supplemental steering angle Δδ_{AFS} of the superimposition steering on the steering pinion gear serve as input quantities for the process.

The steering angles δ_{VARI, req}, Δδ_{GRR, req} and Δδ_{GMK, req} can thereby be transmitted directly by the corresponding control devices. The steering angle Δδ_{AFS} can be determined as the difference between the actual steering wheel angle δ_{LR, Pinion}=i_{AFS}·δ_{LR, SZL} related to the steering pinion gear and the actual total steering angle δ_{SUM, Pinion} on the steering pinion gear that can be detected by an angle sensor, or it is determined in the computing unit of the superimposition steering directly from the engine orientation angle sensor of the superimposition steering.

For the implementation of the process, the actual steering wheel angle δ_{LR, SZL} on the steering wheel is, first of all, as illustrated by means of the block 10, converted into the actual steering wheel angle δ_{LR, Pinion} on the steering pinion gear. This is carried out through the simple multiplication of δ_{LR, SZL} with the known mechanical transmission ratio i_{AFS} of the AFS gear at the multiplication point 10.

An additional multiplication, illustrated in block 30, of δ_{LR, Pinion} with the inverse of the steering gear transmission i_{LG}, yields the actual steering wheel angle δ_{LR, Whl}=δ_{LR,Pinion}·1/i_{LG} on the steerable wheels, whereby the transmission behavior of the steering gear is to be considered as indicated in block 20. This is carried out by means of the known characteristic transmission curve of the steering gear.

The steering angles δ_{VARI, req}, Δδ_{GRR, req} and Δδ_{GMK, req} are first of all added in the block 80, so that the theoretical total steering angle on the wheel is obtained. Through the multiplication with the transmission i_{LG} of the steering gear, as represented by block 100, the theoretical total steering angle δ_{SUM, req} on the steering pinion gear can then be computed. The transmission behavior of the steering gear, particularly the inverse characteristic transmission curve, is thereby to yet again be taken into consideration, as indicated by block 90.

The subtraction between δ_{SUM, req} and δ_{LR, Pinion} at subtraction point 110 yields the theoretical total supplemental steering angle Δδ_{AFS, req} of the superimposition steering on the steering pinion gear, which is compared with the actual total supplemental steering angle Δδ_{AFS} in order to determine the standard deviation εδ_{AFS} for the total steering angle to be set by the superimposition steering. This is carried out by means of subtraction, as is depicted by means of subtraction point 120.

The standard deviation εδ_{AFS} of the total supplemental steering angle determined in that manner is, in accordance with the invention, used to determine a time constant T_{AFS} of a model of the actuator controlling the AFS gear system.

The actuator is an electrical motor which typically has a PT₂-transmission behavior, as is characteristic for delaying and oscillation-capable final control elements.

The actuator of the AFS gear system should not, however, oscillate excessively upon the setting of a preset total supplemental steering angle, since fatal effects on the driving behavior would otherwise have to be expected.

In a very good approximation, a PT, transmission behavior of the actuator can thus be assumed, so that its transmission function can be stated as:

$$G ( s ) = \frac{k}{1 + {T}_{AFS} \cdot s}$$

whereby an amplification factor of k=1 can be taken as the basis here.

The transitional function of the actuator is consequently:
h(t)=1−e^{-/T}^{_{AFS}}

It is stated schematically in block 50, through which an assessed value Δ\tilde{δ}_{VARI} is determined for the actual partial supplemental steering angle Δδ_{VARI} of the VARI by means of the PT₁-model, on the basis of an assessed value \tilde{T}_{AFS}, for the time constant T_{AFS} of the model.

The theoretical partial supplemental steering angle Δδ_{VARI}, req of the VARI on the wheel, which is obtained at the subtraction point 40 by subtraction of the actual steering wheel angle δ_{LR, Whl} on the wheel from the theoretical partial steering angle δ_{VARI, req} on the wheel, thereby serves as the input quantity for the block 50.

The steering angle δ_{VARI, req} relating to the wheel can be used as the input quantity here, since only one modeling of the control behavior of the actuator controlling the AFS gear system is carried out, and not one of the AFS gear system itself.

The theoretical partial supplemental steering angles related to the steering pinion gear or the steering wheel could, however, likewise be used as input quantities for the block 50. The form of implementation depicted has the advantage, however, that the output quantity Δ\tilde{δ}_{VARI}, just like the actual partial steering angle δ_{VARI} of the VARI that is sought, relates to the wheel. Unnecessary conversions between different reference points are consequently avoided.

An assessed value \tilde{δ}_{VARI} for the actual partial steering angle δ_{VARI} of the VARI is to be determined as the output quantity of the entire process. This occurs through the addition of the estimated actual partial supplemental steering angle Δ\tilde{δ}_{VARI} computed by the block 50 and of the actual steering wheel angle δ_{LR, Whl} on the wheel at the addition point 60.

The steering angle \tilde{δ}_{VARI} is an assessed value for the driver steering choice ä_{DRV,req}, which enters into the reference model used by the ESP control device 70 for the determination of the vehicle theoretical behavior.

A single-track model of the ESP control device 70 is thereby preferably used. Different functions of the control device 70, as well as different design concepts for an adjustment of the driving dynamics and, in particular, the reference model, are described in the German patent disclosure document DE 195 15 058 A1, for example. Reference is hereby made at this point to the entire contents of the same.

The block 50, as the standard input parameter, obtains the assessed value \tilde{T}_{AFS} for the time constant T_{AFS} of the AFS actuator.

In the form of implementation of the process in accordance with the invention depicted in FIG. 1, this is determined in stages, which are illustrated by means of the blocks 130, 140 and 150.

First of all, the amount |ε_{δ, AFS}| of the standard deviation ε_{δ, AFS} formed at the subtraction point 120 is computed as depicted in block 130.

It is to be noted that the dynamics of the actuator only change relatively slowly in dependence on the quantities influencing the dynamics—such as the temperature, for example.

Thus, the signal |ε_{δ, AFS}| is filtered through a low-pass filter 140 so that, upon non-sequential changes of the value ε_{δ, AFS}, because of a supplemental steering angle request increasing in a non-sequential manner, no likewise non-sequential and unrealistic change of the estimated time constants \tilde{T}_{AFS} results.

The estimation of \tilde{T}_{AFS} is, in the form of implementation depicted in FIG. 1, carried out by means of a characteristic curve which assigns a value \tilde{T}_{AFS} to every filtered value |\tilde{ε}_{δ, AFS}| of the amount |ε_{δ, AFS}|, as is depicted by block 150.

In the simplest case, the characteristic curve can thereby be used as a gradated function which assigns a small value \tilde{T}_{AFS} representing the normal dynamics of the actuator to every value |\tilde{ε}_{δ,AFS}| that is smaller than a preset threshold value, and assigns a large value \tilde{T}_{AFS} modeling a reduced dynamic to every value |\tilde{ε}_{δ,AFS}| lying above the threshold value. A hysteresis function can, in particular, also hereby be used in combination with the gradated function.

Better and, in particular, more precise results are achieved, however, with a characteristic curve that has a certain range with a transitional behavior between normal and reduced dynamics. A proportionality between \tilde{T}_{AFS} and |\tilde{ε}_{δ,AFS}| can be assumed in the range, for example, as depicted in the characteristic curve indicated in block 150.

The time constant \tilde{T}_{AFS} determined in such a manner can, on the one hand, serve as an input quantity of the block 50 for the computation of the steering angle Δ\tilde{δ}_{VARI}, but it can, however, also be supplied to a unit for monitoring the actuator dynamics.

This is useful, for example, if it is only provided to use the assessed value \tilde{δ}_{VARI} upon reduced actuator dynamics as an input quantity for the ESP control device 70 and, upon normal dynamics, to refer back to the theoretical value δ_{VARI, req}.

The problem has emerged here, however, that no changes of the theoretical total steering angle δ_{SUM, req} to be set by the actuator appear upon a stationary steering behavior of the driver, and that the transmission behavior of the actuator is likewise stationary.

In this case, the standard deviation ε_{δ, AFS} disappears nearly completely, and a time constant \tilde{T}_{AFS} is estimated which corresponds to normal dynamics not even present under certain circumstances.

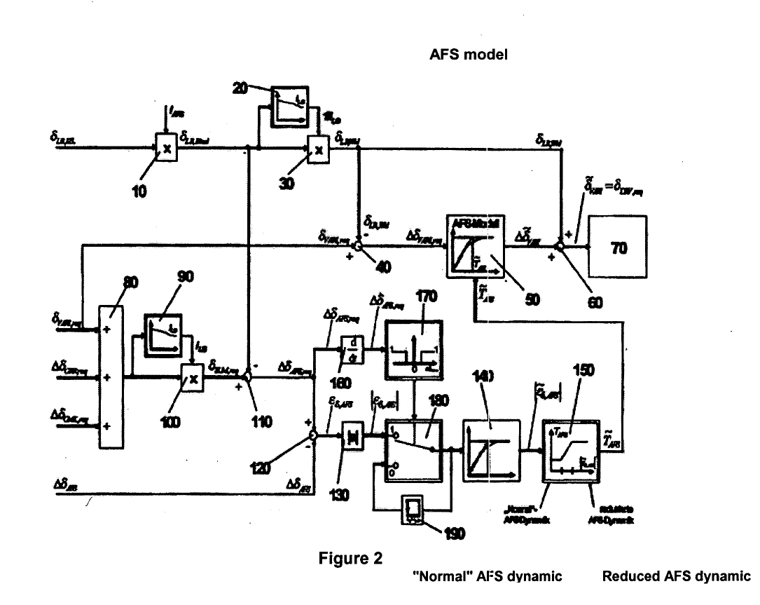

In an additional form of implementation of the process in accordance with the invention illustrated by means of the schematic block diagram in FIG. 2, it is thus provided to only determine the time constant \tilde{T}_{AFS} again if the rate of change Δ\dot{δ}_{AFS,req} of the theoretical total supplemental steering angle Δδ_{AFS}, req exceeds a preset threshold value.

It would at the same also be possible to compare a rate of change Δ\dot{δ}_{AFS} of the actual total supplemental steering angle Δδ_{AFS} with a threshold value, and to only determine the time constant \tilde{T}_{AFS} again, if Δ\dot{δ}_{AFS} exceeds the threshold value.

The rate of change is thereby computed by a differentiation component 160 and conveyed to the block 170. If the value of Δδ_{AFS, req} exceeds the threshold value, then this issues an output signal with the value “one”; otherwise, the output signal, which serves the block 180 as an input signal, states the value “zero”.

The block 180 is connected in series to the blocks 130 and 140, and only transmits the value actually computed |ε_{δ, AFS}| to the low-pass filter 140 if its input signal has the value “one”. Otherwise, the value |ε_{δ, AFS}| transmitted to the filter 140 during the last cycle, which is stored in the block 190, is transmitted again.

In this way, it is possible to compute the applicable time constant \tilde{T}_{AFS} at any time if a stimulus of the system is present. Without a system stimulus, the estimation pauses at the last value determined.

In the forms of implementation explained above, the process in accordance with the invention can also be carried out rapidly and reliably with relatively little use of computing power.

With greater computing power, however, it is possible to carry out a more precise determination of the time constants T_{AFS} by means of parameter estimation processes with greater complexity.

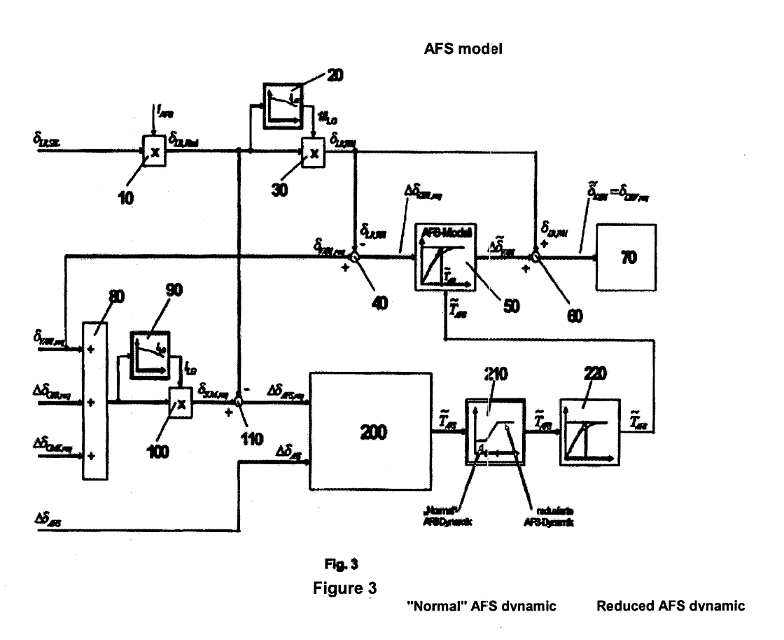

This is depicted in an additional schematic block diagram in FIG. 3.

A suitable parameter estimation process is thereby carried out in block 200, which computes an assessed value \tilde{T}_{AFS} for the time constants T_{AFS} in dependence on the input signals Δδ_{AFS, req} and Δδ_{AFS}.

This is not, however, transmitted directly to block 50 for the determination of Δ\tilde{δ}_{VARI}, but is instead processed by a limiting device 210 and a low-pass filter 220 connected in series.

The limiting device 210 limits the values of \tilde{T}_{AFS} to a range of values between a minimum value representing a normal dynamic of the actuator and a maximum value representing a reduced dynamic.

By that means, erroneous computations of the value \tilde{T}_{AFS} possibly arising are limited in their effects by the block 210.

The low-pass filter 220 connected to the output side of the limiting device 210 has the same function as the low-pass filter 140, that is to say: filtering out unrealistic non-continuous changes from \tilde{T}_{AFS}.

One particularly well-suited process for estimating the time constant is, in the case depicted here by way of example, a model-based parameter estimation process which is based on the PT₁ model of the AFS actuator, which also forms the basis for the computation of Δ\tilde{δ}_{VARI} by the block 50.

The computation is thereby carried out with the help of the differential equation describing the transmission behavior of the actuator (inverse model).

Under the assumption, to be considered as a good approximation, that the AFS actuator has a PT₁ transmission behavior, this differential equation reads:
Δδ_{AFS}+T_{AFS}·Δ\dot{δ}_{AFS}=Δδ_{AFS,req},

whereby the amplification factor “k” was already set to “one” here.

From this equation, the following expression results for the time constant T_{AFS}:

$${T}_{AFS} = \frac{1}{Δ {\dot{δ}}_{AFS}} \cdot [ {Δδ}_{AFS , req} - {Δδ}_{AFS} ] = \frac{{ɛ}_{δ , AFS}}{Δ {\dot{δ}}_{AFS}} (* )$$

whereby all quantities to the right of the first equal sign from the left are known, or can be computed.

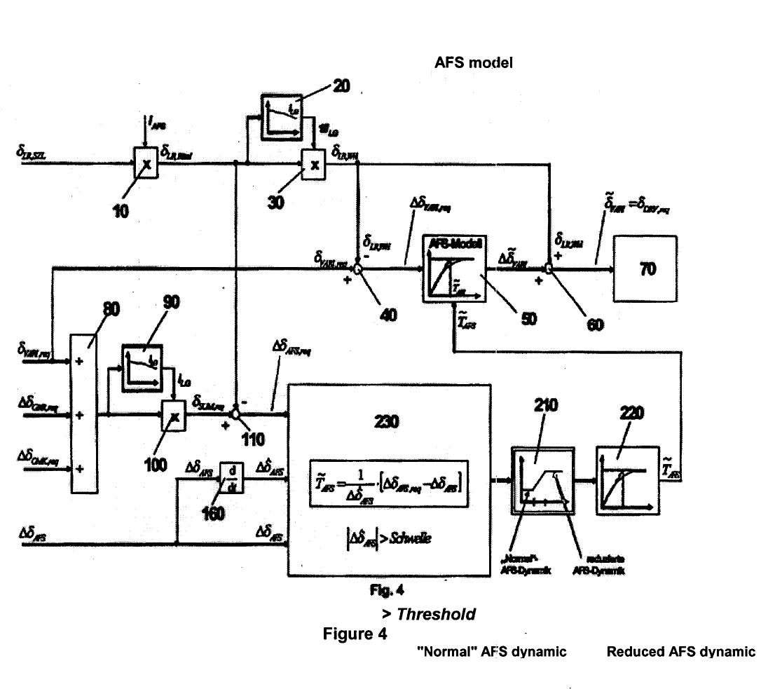

By means of the expression (*), the value \tilde{T}_{AFS} can consequently be determined analytically, as is provided in the form of implementation of the process in accordance with the invention illustrated by the schematic block diagram in FIG. 4.

The analytical computation of \tilde{T}_{AFS} is thereby carried out inside the block 230.

Analogous to the form of implementation depicted by means of FIG. 2, a new value \tilde{T}_{AFS} is only thereby determined and transmitted to the limiting device 210 if the amount |Δ\dot{δ}_{AFS}| exceeds a preset threshold value. Otherwise, the last value \tilde{T}_{AFS} determined is transmitted to the limiting device 210.

In this form of implementation, the comparison of |Δ\dot{δ}_{AFS,req}| with the threshold value is thereby likewise possible. This is not preferred here, however, since the rate of change Δ\dot{δ}_{AFS}, in contrast to the rate of change Δ\dot{δ}_{AFS,req}, is used for the determination of \tilde{T}_{AFS}, and thus simply must be determined.

In the forms of implementation of the process in accordance with the invention described above, the estimated actual partial steering angle \tilde{δ}_{VARI} of the VARI on the wheel is determined by the addition of the estimated actual partial supplemental steering angle Δ\tilde{δ}_{VARI} and of the actual steering wheel angle δ_{LR, Whl} on the wheel.

It is likewise possible, however, through the subtraction of an estimated actual partial total supplemental steering angle Δ\tilde{δ}_{Σ}, which corresponds to an assessed value of the sum Δδ_{Σ}=Δδ_{GRR}+Δδ_{GMK} of the actual partial supplemental steering angle Δδ_{GRR} and Δδ_{GMK} of the GRR and of the GMK, to obtain from the actual total steering angle δ_{SUM, Whl} on the wheels: \tilde{δ}_{VARI}=δ_{SUM,Whl}−Δ\tilde{δ}_{Σ}.

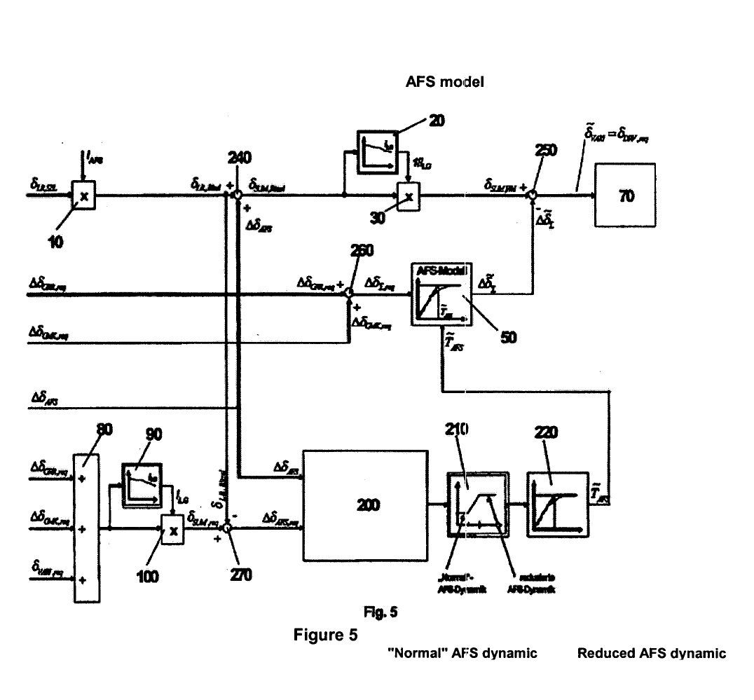

This is depicted in an additional schematic block diagram in FIG. 5, whereby a general parameter estimation process for the determination of \tilde{T}_{AFS} is carried out in block 200 again.

The input signals Δδ_{AFS} and Δδ_{AFS, req} are determined in the same way as was carried out with the forms of implementation of the process described above.

Through the addition of the actual steering wheel angle δ_{LR, Pinion} on the steering pinion gear, and of the actual total supplemental steering angle Δδ_{AFS} to the summation point 240, the actual total steering angle δ_{SUM, Pinion} on the steering pinion gear is determined and is, through multiplication with the inverse steering gear transmission i_{LG}, as illustrated in FIG. 5 by means of the blocks 20 and 30, conveyed to the actual total steering angle δ_{SUM, Whl} on the wheels.

The theoretical partial total supplemental steering angle Δδ_{Σ, req}, which is obtained at the summation point 260 as a sum from the theoretical partial supplemental steering angle Δδ_{GRR, req} of the GRR and the theoretical partial supplemental steering angle Δδ_{GMK, req} of the GMK, serves here as the input quantity for the block 50.

By means of the value Δδ_{Σ, req}, computation is carried out in the assessed value Δ\tilde{δ}_{Σ} for the actual partial total supplemental steering angle Δδ_{Σ} through the block 50 simulating the transmission behavior of the AFS actuator.

This is deducted from the actual total steering angle δ_{SUM, Whl} at the subtraction point 250, so that the assessed value sought \tilde{δ}_{VARI}, which is conveyed to the ESP control device, is obtained behind the subtraction point.

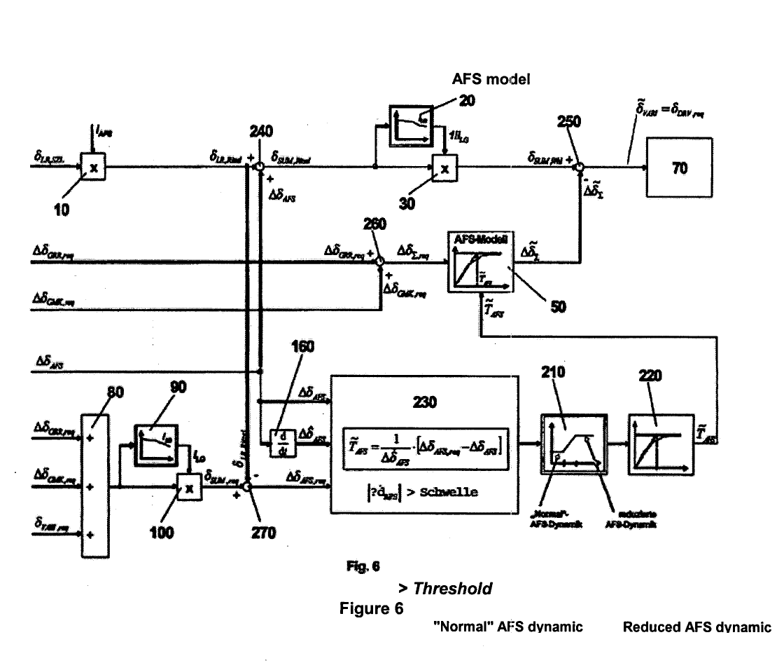

In the schematic block diagram in FIG. 6, block 200 of the schematic block diagram in FIG. 5 is replaced by block 230, by means of which the model-based parameter estimation process is carried out in the way that was described in connection with FIG. 4.

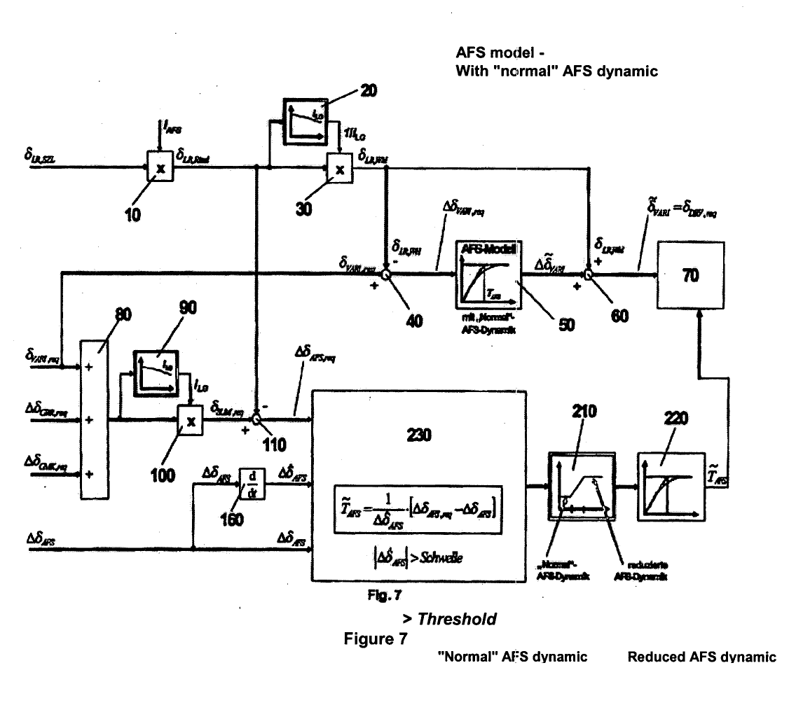

Yet another form of implementation of the process in accordance with the invention is depicted in FIG. 7 by means of the schematic block diagram. In the circuit configuration, it corresponds to the schematic block diagram in FIG. 4, with the difference that the assessed value \tilde{T}_{AFS} is not conveyed to block 50, but to the ESP control unit 70.

By means of the block 50, the estimated actual partial supplemental steering angle Δ\tilde{δ}_{VARI} is determined from the theoretical partial supplemental steering angle Δδ_{VARI}, req by means of the actuator model, with the time constants T_{AFS} representing the normal dynamics of the actuator.

The consideration of a dynamic of the actuator reduced under certain circumstances is carried out within the ESP control device 70 by means of a threshold expansion in the control unit contained.

This computes a control variable if the standard deviation between the theoretical value of the driving condition quantity and the determined actual value exceeds a preset threshold value.

In dependence on the estimated value \tilde{T}_{AFS} for the time constant T_{AFS}, the threshold value in the form of implementation of the process in accordance with the invention illustrated by means of FIG. 7 is adjusted to the dynamics of the actuator. In particular, the threshold value is thereby increased if an assessed value \tilde{T}_{AFS} representing a reduced actuator dynamic results.

Defective control interventions of the ESP control unit due to reduced actuator dynamics are consequently also effectively impeded in this form of implementation of the process.

In summary, it is noted that the present invention creates an advantageous process which makes it possible to be able to carry out a reliable adjustment of driving dynamics with interventions in the steering of a vehicle, even if the dynamics of the actuator intervening in the steering are restricted, such as may be the case, for example, at very low temperatures, a few minutes after the starting of the vehicle.

### LIST OF REFERENCES

δ_{VARI, req}: Theoretical partial steering angle of the VARI, reference point: wheel.
δ_{VARI}: Actual partial steering angle of the VARI, reference point: wheel.
\tilde{δ}_{VARI} Estimated actual partial steering angle of the VARI, reference point: wheel.
Δδ_{VARI, req}: Theoretical partial supplemental steering angle of the VARI, reference point: wheel.
Δδ_{VARI}: Actual partial supplemental steering angle of the VARI, reference point: wheel.
Δ\tilde{δ}_{VARI}: Estimated actual partial supplemental steering angle of the VARI, reference point: wheel.
Δδ_{GRR, req}: Theoretical partial supplemental steering angle of the GRR, reference point: wheel.
Δδ_{GRR}: Actual partial supplemental steering angle of the GRR, reference point: wheel.
Δ\tilde{δ}_{GRR}: Estimated actual partial supplemental steering angle of the GRR, reference point: wheel.
Δδ_{GMK, req}: Theoretical partial supplemental steering angle of the GMK, reference point: wheel.
Δδ_{GMK}: Actual partial supplemental steering angle of the GMK, reference point: wheel.
Δ\tilde{δ}_{GMK}: Estimated actual partial supplemental steering angle of the GMK, reference point: wheel.
δ_{LR, SZL}: Actual steering wheel angle, reference point: steering wheel.
δ_{LR, Pinion}: Actual steering wheel angle, reference point: steering pinion gear.
δ_{LR, Whl}: Actual steering wheel angle, reference point: wheel.
δ_{DRV, req}: Input quantity for the ESP or DSC control device, “driver steering choice”, reference point: wheel.
δ_{SUM, req}: Theoretical total steering angle, reference point: steering pinion gear.
δ_{SUM, Pinion}: Actual total steering angle, reference point: steering pinion gear.
δ_{SUM, Whl}: Actual total steering angle, reference point: wheel.
Δδ_{Σ, req}: Theoretical partial total supplemental steering angle (sum of the theoretical partial supplemental steering angle of the GRR and of the GMK), reference point: wheel.
Δδ_{Σ}: Actual partial total supplemental steering angle (sum of the actual partial supplemental steering angle of the GRR and of the GMK), reference point: wheel.
Δ\tilde{δ}_{Σ}: Estimated actual partial total supplemental steering angle (sum of the estimated actual partial supplemental steering angle of the GRR and of the GMK), reference point: wheel.
Δδ_{AFS, req}: Theoretical total supplemental steering angle for the AFS gear system, reference point: steering pinion gear
Δδ_{AFS}: Actual total supplemental steering angle that was set by the AFS gear system, reference point: steering pinion gear.
Δ\dot{δ}_{AFS,req}: Theoretical total supplemental steering angle gradient for the AFS gear system, reference point: steering pinion gear.
Δ\dot{δ}_{AFS}: Actual total supplemental steering angle gradient that was set by the AFS gear system, reference point: steering pinion gear
T_{AFS}: Time constant of the actuator model
\tilde{T}_{AFS}: Estimated time constant of the actuator model
ε_{δ, AFS}: Standard deviation of the total supplemental steering angle for the AFS gear system
   |ε_{δ,AFS}|: Amount of the standard deviation of the total supplemental steering angle for the AFS gear system
   |\tilde{ε}_{δ,AFS}|: Filtered amount of the standard deviation of the total supplemental steering angle for the AFS gear system
i_{AFS}: Steering transmission of the AFS gear system
i_{LG}: Mechanical transmission of the steering gear
10 Multiplication point
20 Block with the transmission behavior of the steering gear
30 Multiplication point
40 Subtraction point
50 Block with the modeled transmission behavior of the actuator
60 Addition point
70 ESP control unit
80 Addition point
90 Block with the transmission behavior of the steering gear
100 Multiplication point
110 Subtraction point
120 Subtraction point
130 Block for formation of the amount
140 Low-pass filter
150 Block for coordination between standard deviation and time constant by means of a characteristic curve
160 Differential element
170 Logic unit for the comparison of the standard deviation with a threshold value
180 Block for the transfer of the standard deviation
190 Block for the storage in memory
200 Block for the implementation of a parameter estimation process
210 Limiting device
220 Low-pass filter
230 Block for the computation of the time constants by means of a actuator model
240 Addition point
250 Subtraction point
260 Addition point

1. Process for the determination of an actual value of a control variable set by an actuator in accordance with a theoretical value, characterized in that, a partial value (Δδ_{VARI}; Δδ_{Σ}) of an actual value (Δδ_{AFS}) set in accordance with a theoretical total value (Δδ_{AFS, req}) consisting of a sum of theoretical partial values (Δδ_{VARI, req}, Δδ_{GRR, req}, Δδ_{GMK, req}) is determined, in dependence on the theoretical partial value (Δδ_{VARI, req}; Δδ_{Σ, req}) corresponding to the partial value (Δδ_{VARI}; Δδ_{Σ}), in an actuator model formed with at least one parameter (T_{AFS}), whereby the value (\tilde{T}_{AFS}) of the parameter (T_{FAS}) is determined by means of a divergence (ε_{δ, AFS}) between the theoretical total value (Δδ_{AFS, req}) and a determined actual total value (Δδ_{AFS}) of the control variable.

2. Process in accordance with claim 1, characterized in that, the value (\tilde{T}_{AFS}) of the parameter (T_{AFS}) is assigned to the value of the deviation (ε_{δ, AFS}) by means of a characteristic curve.

3. Process in accordance with one or both of the claims 1 and 2, characterized in that, the value (\tilde{T}_{AFS}) of the parameter (T_{AFS}) is determined by means of an actuator model or a parameter estimation process.

4. Process in accordance with one or more of the preceding claims, characterized in that, the value (\tilde{T}_{AFS}) of the parameter (T_{AFS}) is determined by means of the same actuator model as the partial value (Δδ_{VARI}; Δδ_{Σ}) of the actual value (Δδ_{AFS}) of the control variable.

5. Process in accordance with one or more of the preceding claims, characterized in that, a value (\tilde{T}_{AFS}) for the parameter (T_{AFS}) is only determined if the rate of change (Δ\dot{δ}_{AFS,req}) of the total theoretical value (Δδ_{AFS, req}) and/or the rate of change (Δ\dot{δ}_{AFS}) of the total actual value (Δδ_{AFS}) exceeds a preset threshold value.

6. Process in accordance with one or more of the preceding claims, characterized in that, a value (\tilde{T}_{APS}) for the parameter (T_{AFS}) is retained if the rate of change (Δ\dot{δ}_{AFS,req}) of the total theoretical value (Δδ_{AFS, req}) and/or the rate of change (Δ\dot{δ}_{AFS}) of the total actual value (Δδ_{AFS}) lies below the preset threshold value.

7. Process in accordance with one or more of the preceding claims, characterized in that, the value (\tilde{T}_{AFS}) of the parameter (T_{AFS}) is limited to a preset interval.

8. Process in accordance with one or more of the preceding claims, characterized in that, a time constant (T_{AFS}) is determined as the parameter of an actuator model describing a transmission behavior of the actuator.

9. Process in accordance with one or more of the preceding claims, characterized in that, an assessed value (Δ\tilde{δ}_{VARI}; Δ\tilde{δ}_{Σ}) is determined for an actual partial value (Δδ_{VARI}; Δδ_{Σ}) of a steering angle (Δδ_{AFS}) set by an actuator of a superimposition steering on the steerable wheels of a vehicle.

10. Process in accordance with one or more of the preceding claims, characterized in that, an assessed value (Δ\tilde{δ}_{VARI}) is determined for an actual partial value (Δδ_{VARI}) of a steering angle changing a transmission ratio of a steering of the vehicle in a manner dependent upon speed, and set by means of a superimposition steering.
